(19) United States
(12) Patent Application Publication
(10) Pub. No.: US 2009/0239726 A1
(43) Pub. Date: Sep. 24, 2009

(54) SYSTEM AND APPARATUS FOR ERECTING CASES

(76) Inventor: Jindai Huang, Surrey (CA)

Correspondence Address: THOMPSON HINE L.L.P.;Intellectual Property Group, P.O. BOX 8801, DAYTON, OH, 45401-8801, US

(21) Appl. No.: 12/053,333

(22) Filed: Mar. 21, 2008

(51) Int. Cl. B31B 1/78

(52) U.S. Cl. 493/309

(57) ABSTRACT

A case forming apparatus that erects cases from knocked-down case blanks includes a first jaw and a plurality of stabilizer bars each having a first end mounted to the first jaw. The stabilizer bars are spaced radially from each other and form concentric segments of circles centered on a pivotal axis. A moveable second jaw is mounted for movement on the pivotal axis relative to the first jaw between an open position where the moveable second jaw is substantially perpendicular to the first jaw and a closed position where the moveable second jaw is substantially parallel to the first jaw. The moveable second jaw includes openings through which the stabilizer bars pass as the moveable second jaw moves between the open and closed positions. At least one of the stabilizer bars has a cross-sectional width that varies over at least one-third of a cross-sectional height of the at least one stabilizer bar.

### TECHNICAL FIELD

The present application relates to systems and apparatus for erecting cases and a stabilizer bar system for use with same.

### BACKGROUND

In the erecting of a carton or case from a knocked down blank, the knocked down carton or case is opened do that adjacent sides form a right angle and then the bottom flaps folded into closed position. The erecting operation generally withdraws a single knocked down case blank from a magazine of such blanks held in face to face position, opens the flat blank from the knocked down condition into a square-corner condition wherein adjacent side walls of the case are generally mutually perpendicular and positions the erected blank into a bottom flap folding station. In the bottom flap folding station, the minor flaps (generally the shorter flaps), one connected to each of the leading and trailing side panels of the case (oriented in the direction of travel of the case from the erecting station), are folded relative to their respective side panels and then the major flaps one connected to each of the remaining side wall (walls parallel to the direction of travel) are folded into underlining relation (outwardly exposed relation) to the minor flaps.

The erected case is then moved into a bottom closure station, which may be a taping station where a tape or adhesive is applied along the bottom major flaps extending in the direction of travel of the case through the taping station to secure the major flaps in folded closed position and thereby the case in erected condition with the adjacent side panels mutually perpendicular. In this condition, the top closing flaps are generally open so that the case may be filled and then the top flaps are closed and secured in closed position for example by taping or adhesive similar to the bottom taping operation to complete the erecting filling and closing cycle and the filed box is ready for shipment.

### SUMMARY

In an aspect, a case forming apparatus that erects cases from knocked-down case blanks includes a first jaw and a plurality of stabilizer bars each having a first end mounted to the first jaw. The stabilizer bars are spaced radially from each other and form concentric segments of circles centered on a pivotal axis. A moveable second jaw is mounted for movement on the pivotal axis relative to the first jaw between an open position where the moveable second jaw is substantially perpendicular to the first jaw and a closed position where the moveable second jaw is substantially parallel to the first jaw. The moveable second jaw includes openings through which the stabilizer bars pass as the moveable second jaw moves between the open and closed positions. One or more of the stabilizer bars has a cross-sectional width that varies over at least one-third of a cross-sectional height of the at least one stabilizer bar.

In another aspect, a case forming apparatus that erects cases from knocked-down case blanks includes a first jaw and a plurality of stabilizer bars each having a first end mounted to the first jaw. The stabilizer bars are spaced radially from each other and form concentric segments of circles centered on a pivotal axis. A moveable second jaw is mounted for movement on the pivotal axis relative to the first jaw between an open position where the moveable second jaw is substantially perpendicular to the first jaw and a closed position where the moveable second jaw is substantially parallel to the first jaw. The moveable second jaw includes openings through which the stabilizer bars pass as the moveable second jaw moves between the open and closed positions. At least one of the stabilizer bars includes an intermediate portion with a cross-sectional surface area that is less than that of the first end.

In another aspect, a case forming apparatus that erects cases from knocked-down case blanks includes a first jaw and a plurality of stabilizer bars each having a first end mounted to the first jaw. The stabilizer bars are spaced radially from each other and form concentric segments of circles centered on a pivotal axis. A moveable second jaw is mounted for movement on the pivotal axis relative to the first jaw between an open position where the moveable second jaw is substantially perpendicular to the first jaw and a closed position where the moveable second jaw is substantially parallel to the first jaw. The moveable second jaw includes openings through which the stabilizer bars pass as the moveable second jaw moves between the open and closed positions. A support member includes a lift mechanism for changing an elevation of the moveable second jaw and the first jaw, the first jaw being mounted directly to the support member. A support beam is mounted directly to the support member wherein a second end of each stabilizer bar is mounted to the support beam.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a perspective view of an embodiment of a case forming apparatus;

FIGS. 2 and 3 are perspective views of an embodiment of a case erecting system for use in the case forming apparatus in open and closed positions, respectively;

FIG. 4 is a top view of an embodiment of a stabilizer bar for use with the case erecting system of FIGS. 2 and 3;

FIGS. 5 and 6 are detail views of opposite ends of the stabilizer bar of FIG. 4;

FIG. 7 is a section view of multiple stabilizer bars including the stabilizer bar of FIG. 4 along line 7-7;

FIG. 8 is a section view of another embodiment of a stabilizer bar; and

FIG. 9 is a section view of another embodiment of a stabilizer bar.

### DETAILED DESCRIPTION

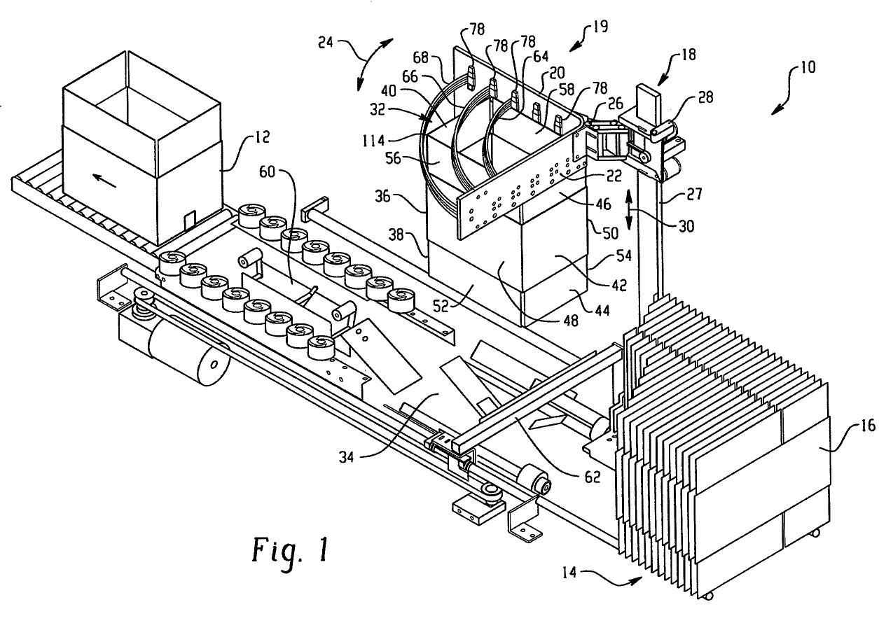

Referring to FIG. 1, an apparatus 10 for erecting and sealing a case 12 includes a magazine 14 holding a number of knocked-down case blanks 16. The case blanks 16 are extracted from the magazine 14 and squared using an erecting system 18. The erecting system 18 includes a jaw assembly 19 including a pair of jaws 20 and 22, where jaw 20 is moveable and jaw 22 is fixed (relative to the jaw assembly). The moveable jaw 20 is pivoted using a suitable drive mechanism as represented and indicated by arrow 24 on a pivotal axis or hinge 26 between a pick-up or gripping position where the jaws 20 and 22 are in an opposed, substantially parallel relationship and open position where the jaws are in a substantially perpendicular relationship.

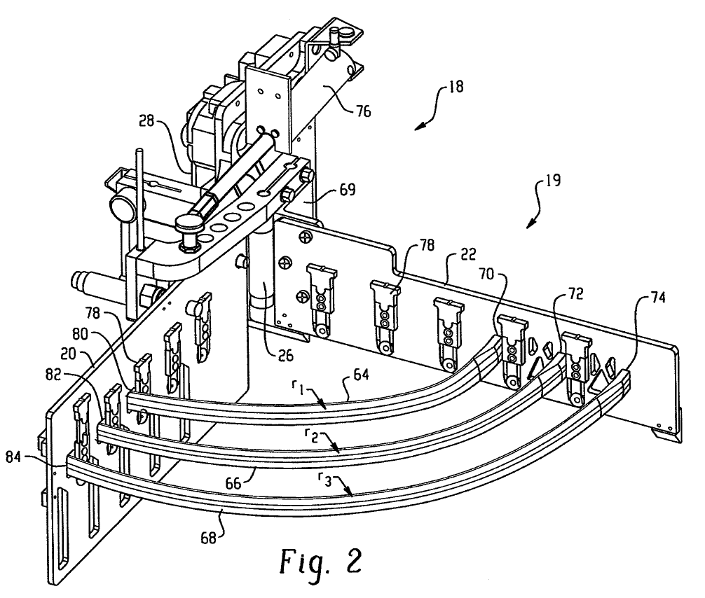

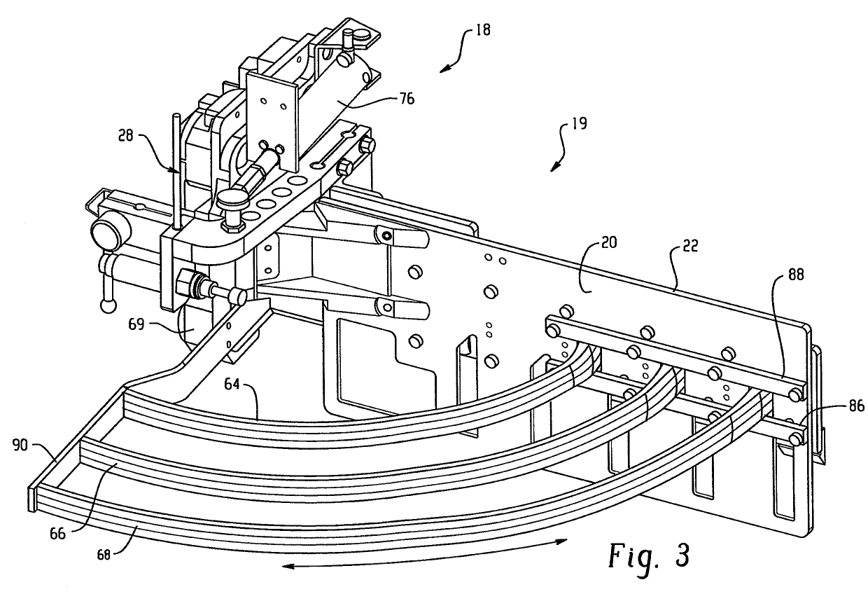

The moveable jaw 20 and fixed jaw 22 are also moveable vertically along a track member 27 by a lift mechanism carriage or traveler 28 that moves the jaw assembly 19 as indicated by arrow 30. The fixed and moveable jaws 20 and 22 receive a knocked-down case blank 16 with the jaws in their closed or pick-up position (as shown in FIG. 3) and move the case blank 16 from the magazine 14. The moveable jaw 20 is then moved relative to the fixed jaw 22 to the position illustrated (i.e., the open position as also shown in FIG. 2) to open the blank into a square-corner condition (now indicated by element 32). The erected case 32 is then moved downward as indicated by arrow 30 into the bottom flap folding station 34.

The erected case 32 has a leading wall panel 36 (leading in the direction of movement of the case through the apparatus 10) to which are connected a leading bottom flap 38 and a leading top flap 40. The erected case 32 has a corresponding trailing wall panel 42 with a trailing bottom flap 44 and a trailing top flap 46. The leading and trailing wall panels 36 and 42 are connected by a pair of opposed side wall panels 48 and 50, each with a side bottom flap 52, 54 and a side top flap 56, 58. The shorter leading and trailing wall panels 36 and 42 and flaps 38, 40, 44 and 46 are generally referred to as minor side walls and flaps and the longer side wall panels 48 and 50 and flaps 52, 54, 56 and 58 are generally referred to a major wall panels and flaps. The major wall panels and flaps 48, 50, 52, 54, 56 and 58 may, but not necessarily, be oriented parallel to the direction of travel, e.g., so that the major flaps are folded last and exposed as the erected case 32 is moved into a bottom sealing station 60.

The folding station 34 is provided with flap folding equipment for folding the leading bottom minor flap 38 and the trailing bottom minor flap 44. The folding station 34 folds the leading and trailing bottom flaps 38 and 44 to positions substantially perpendicular to their corresponding leading and trailing wall panels 36 and 42 as the case is moved in the machine direction. The major bottom flaps 52 and 54 are then folded substantially perpendicular to their corresponding side wall panels 48 and 50.

The erected case 32 with its bottom flaps 38, 44, 52 and 54 folded is then advanced into and through the bottom sealing station 60 by any suitable mechanism, in the illustrated embodiment, a pusher mechanism 62.

Referring now to FIGS. 2 and 3, components of the erecting system 18 including the jaws 20 and 22 of jaw assembly 19 are illustrated in greater detail. FIG. 2 illustrates the moveable and fixed jaws 20 and 22 in their open position and FIG. 3 illustrates the moveable and fixed jaws in their closed positions. The fixed and moveable jaws 22 and 20 are mounted to a support member 69. The support member 69 includes the lift mechanism traveler 28 that rides along the track member 27 (FIG. 1). Stabilizer bars 64, 66 and 68 are mounted in fixed relation to the fixed jaw 22 as indicated at 70, 72 and 74. The stabilizer bars 64, 66 and 68 form quadrants of concentric circles indicated by the radii r₁, r₂ and r₃, respectively (FIG. 2) centered on the hinged or pivotal axis 26 about which the moveable jaw 20 is pivoted. An actuator 76 (e.g., a pneumatic cylinder) is used to pivot the moveable jaw 20 about the pivotal axis 26.

Gripping pins 78, such as those described in U.S. Pat. Nos. 4,553,954, 7,192,393 and 7,316,643, are positioned adjacent to and between the mountings 70, 72 and 74 of the stabilizer bars 64, 66 and 68 on the fixed jaw 22. Similar gripping pins 78 are provided on the moveable jaw 20, but are positioned on the opposite side of their respective adjacent stabilizer bar 64, 66, 68 as compared to the gripping pins on the fixed jaw 22. The gripping pins 78 are placed in this staggered relationship so that they do not collide together and interfere with the closing of the jaws 20 and 22.

The stabilizer bars 64, 66 and 68 pass through respective openings 80, 82 and 84 in the moveable jaw 20. As shown by FIG. 3, panels 86 and 88 are located above and below the stabilizer bars 64, 66 and 68 and mounted to the moveable jaw 20. The panels 86 and 88 are made of a material that facilitate movement of the moveable jaw 20 along the stabilizer bars 64, 66 and 68 should the stabilizer bars contact the panels.

As indicated above, the stabilizer bars 64, 66 and 68 are mounted at one end to the fixed jaw 22. The fixed jaw 22 is, in turn, mounted to the support member 69. The other end of the stabilizer bars 64, 66 and 68 is mounted to a rigid support beam 90 (FIG. 3). The rigid support beam 90 is, in turn, mounted to the support member 69 so that both ends of the stabilizer bars 64, 66 and 68 are connected to the support member. In other words, the ends of the stabilizer bars 64, 66 and 68 opposite the fixed jaw 22 are not free hanging, unconnected to the support member 69. In addition to supporting the ends of the stabilizer bars 64, 66 and 68 opposite the fixed jaw 22, the support beam 90 interconnects the stabilizer bars, which maintains spacing between the ends.

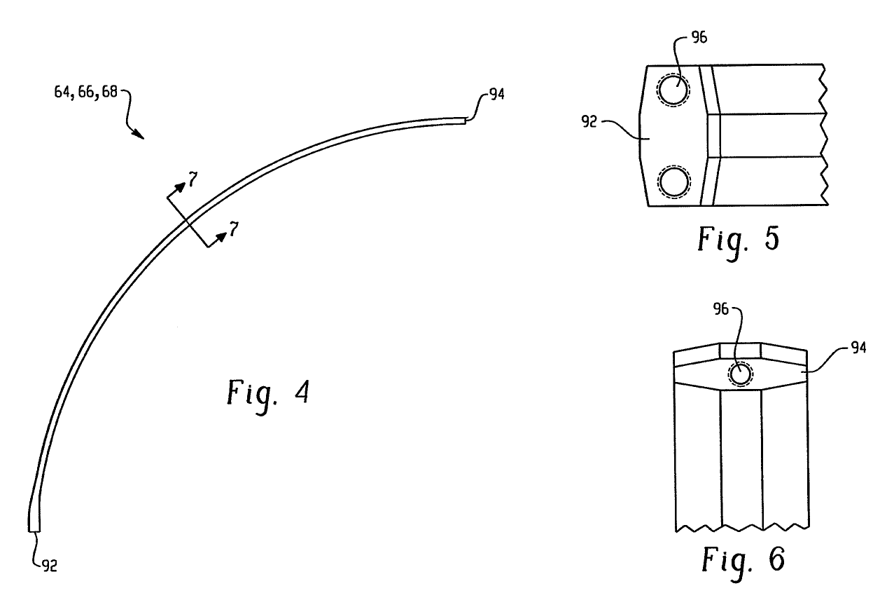

FIG. 4 shows one of the stabilizer bars 64, 66 or 68 in isolation. While only one stabilizer bar is described in detail, each stabilizer bar has a similar construction. The stabilizer bar 64, 66 or 68 includes the end 92 (FIG. 5) that is mounted to the fixed jaw 22 and the end 94 (FIG. 6) that is mounted to the support beam 90. While any suitable mounting may be used, threaded fasteners are inserted into threaded openings 96 located at each end 92 and 94 to mount the ends to the fixed jaw 22 and the support beam 90. As can be seen, end 92 is wider in dimension than end 94. The wider end 92 also provides a larger connection point to the fixed jaw 22 to accommodate the mounting fasteners and provide increase strength where forces on the stabilizer bars are the greatest. End 92 tapers down to a narrower width that is substantially constant along the remaining length (e.g., about 70 degrees of arcuate length) of the stabilizer bar 64, 66 or 68.

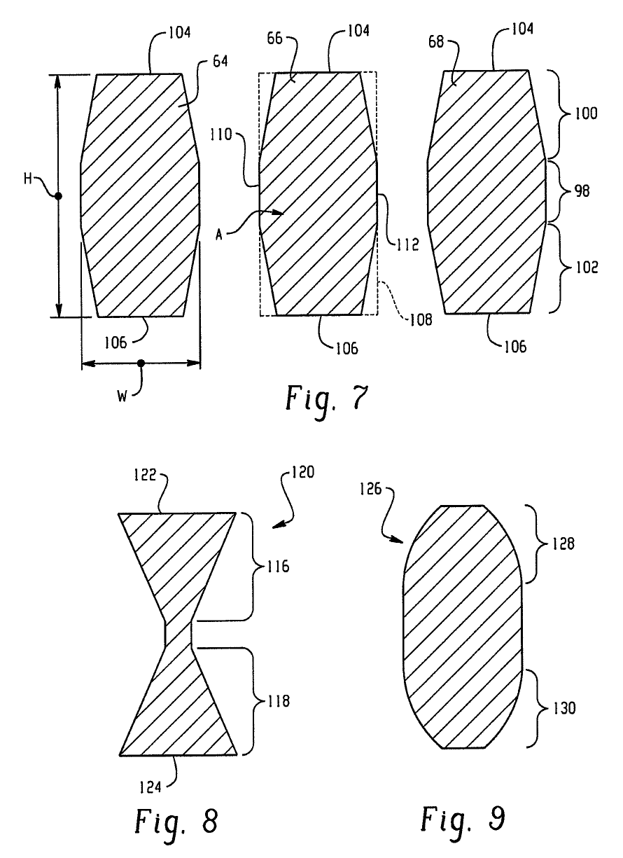

FIG. 7 illustrates a section view (see FIG. 4) of each stabilizer bar 64, 66 and 68. The stabilizer bars 64, 66 and 68 have essentially the same cross-sectional shape along the majority of their lengths. Each stabilizer bar 64, 66 and 68 includes a mid section 98 having a greatest width and upper and lower tapered sections 100 and 102 that taper in width to upper and lower surfaces 104 and 106. A width of each stabilizer bar 64, 66 and 68 varies over at least one-third (e.g., two-thirds) of a height H of each stabilizer bar with the width of the mid section 98 remaining substantially constant. Thus, each stabilizer bar 64, 66 and 68 has a cross-sectional area A that is less than an imaginary rectangle (represented by dashed line 108) bounded by the upper surface 104, the lower surface 106 and side surfaces 110 and 112.

Referring also to FIG. 1, the lower surfaces 106 of the stabilizer bars 64, 66 and 68 are arranged in a common radial plane and are positioned to engage top edges of the upper flaps 40 and 56 adjacent to a free corner 114 of the erected case 32 so that this corner is positioned at a same elevation as an opposite corner of the erected case when the case is forced down into the bottom folding station 34. Contact between the bottom flaps with elements of the bottom folding station 34 will not move the erected case upward past the radial plane, which could distort the completed case.

Providing the cross-sectional arrangement for the stabilizer bars 64, 66 and 68 shown in FIG. 7 limits the surface 106 in contact with top edges of the front minor flap 40 and side major flap 46 of the case 32 as shown in FIG. 1. Should there be a collision of the bottom case flaps 38, 44, 52 and/or 54 with the bottom folding station 34 (e.g., due to improper adjustment or other reasons), the stabilizer bars 64, 66 and 68 will act as dull knives and cut into or crush the corrugated paperboard material of the case rather than be unduly deformed by the upward forces caused by the collision. In some embodiments, various dimensions of the surface 106 may be selected based on characteristics of the paperboard material used to form the cases 32. Upper surface 104 is substantially the same dimension as the lower surface 106 as some cases require opening in an opposite hand direction to that shown by FIG. 1. In these embodiments, an alternative mirror image mechanism is used where the stabilizer bars 64, 66 and 68 are mounted upside down relative to the positions shown in FIGS. 1-3. The bar width W at the center between surfaces 110 and 112 is greater than that at the upper and lower surfaces 104 and 106 to provide greater strength and rigidity of the bars with minimum weight overall compared to rectangular section bars.

The erected case 32 is relatively large and its free corner 114 engages or is located nearest the largest radius stabilizer bar 68. For smaller cases, the other stabilizer bars 64 or 66 may contact or be nearest the free corner of the case. Thus, a number or range of case sizes may be erected without requiring substantial modification of the equipment thereby significantly decreasing downtime when the case size being erected is changed significantly.

Various adjustment systems may be used to adjust various elements of the apparatus 10. For example, the positions of the moveable and fixed jaws 20 and 22 may be adjusted relative to each other. In some embodiment, an adjustment system may be provided to adjust the size of a gap G between the moveable and fixed jaws 20 and 22 when in the closed position (see FIG. 3).

It is to be clearly understood that the above description is intended by way of illustration and example only and is not intended to be taken by way of limitation, and that changes and modifications are possible. For example, other cross-sections for the stabilizer bars may be used. FIG. 8 shows an alternative embodiment where upper and lower sections 116 and 118 of stabilizer bar 120 taper inwardly from top and bottom surfaces 122 and 124 toward the middle. FIG. 9 shows another stabilizer bar embodiment 126 having curved sections 128 and 130. Accordingly, other embodiments are within the scope of the following claims.

What is claimed is:

1. A case forming apparatus that erects cases from knocked-down case blanks, the apparatus comprising:
a first jaw;
a plurality of stabilizer bars each having a first end mounted to the first jaw, the stabilizer bars being spaced radially from each other and forming concentric segments of circles centered on a pivotal axis;
a moveable second jaw mounted for movement on the pivotal axis relative to the first jaw between an open position where the moveable second jaw is substantially perpendicular to the first jaw and a closed position where the moveable second jaw is substantially parallel to the first jaw, the moveable second jaw including openings through which the stabilizer bars pass as the moveable second jaw moves between the open and closed positions;
wherein at least one of the stabilizer bars has a cross-sectional width that varies over at least one-third of a cross-sectional height of the at least one stabilizer bar.

2. The apparatus of claim 1, wherein the cross-sectional width of the at least one stabilizer bar varies over at least two-thirds of the cross-sectional height of the at least one stabilizer bar.

3. The apparatus of claim 1, wherein each stabilizer bar has a cross-sectional width that varies over at least one-third of a cross-sectional height of the stabilizer bar.

4. The apparatus of claim 3, wherein each stabilizer bar has a mid section, an upper section and a lower section, the upper section tapering inwardly from the mid section toward an upper surface and the lower section tapering inwardly from the mid section toward a lower surface.

5. The apparatus of claim 3, wherein each stabilizer bar has a cross-section that is non-rectangular.

6. The apparatus of claim 1 further comprising a support member including a lift mechanism for changing elevation of the moveable second jaw and the first jaw, the first jaw mounted directly to the support member.

7. The apparatus of claim 6 further comprising a support beam mounted directly to the support member wherein a second end of each stabilizer bar is mounted to the support beam.

8. A case forming apparatus that erects cases from knocked-down case blanks, the apparatus comprising:
a first jaw;
a plurality of stabilizer bars each having a first end mounted to the first jaw, the stabilizer bars being spaced radially from each other and forming concentric segments of circles centered on a pivotal axis;
a moveable second jaw mounted for movement on the pivotal axis relative to the first jaw between an open position where the moveable second jaw is substantially perpendicular to the first jaw and a closed position where the moveable second jaw is substantially parallel to the first jaw, the moveable second jaw including openings through which the stabilizer bars pass as the moveable second jaw moves between the open and closed positions;
wherein at least one of the stabilizer bars includes an intermediate portion with a cross-sectional surface area that is less than that of the first end.

9. The apparatus of claim 8, wherein the cross-sectional surface area of the intermediate portion is less than that of a second end of the at least one stabilizer bar.

10. The apparatus of claim 9, wherein the intermediate portion extends for at least 70 degrees of arcuate length of the at least one stabilizer bar.

11. A case forming apparatus that erects cases from knocked-down case blanks, the apparatus comprising:
a first jaw;
a plurality of stabilizer bars each having a first end mounted to the first jaw, the stabilizer bars being spaced radially from each other and forming concentric segments of circles centered on a pivotal axis;
a moveable second jaw mounted for movement on the pivotal axis relative to the first jaw between an open position where the moveable second jaw is substantially perpendicular to the first jaw and a closed position where the moveable second jaw is substantially parallel to the first jaw, the moveable second jaw including openings through which the stabilizer bars pass as the moveable second jaw moves between the open and closed positions;
a support member including a lift mechanism for changing an elevation of the moveable second jaw and the first jaw, the first jaw mounted directly to the support member; and
a support beam mounted directly to the support member wherein a second end of each stabilizer bar is mounted to the support beam.

12. The apparatus of claim 11, wherein each stabilizer bar has a cross-sectional width that varies over at least one-third of a cross-sectional height of the stabilizer bar.

13. The apparatus of claim 11, wherein each stabilizer bar has a mid section, an upper section and a lower section, the upper section tapering inwardly from the mid section toward an upper surface and the lower section tapering inwardly from the mid section toward a lower surface.

14. The apparatus of claim 11, wherein each stabilizer bar has a cross-section that is non-rectangular.
